(19) United States
(12) Patent Application Publication
(10) Pub. No.: US 2022/0353779 A1
(43) Pub. Date: Nov. 3, 2022

(54) Mobile-to-Mobile BGP IP Routing

(71) Applicant: Curvalux UK Limited, Sheffield (GB)

(72) Inventor: Thomas Kyo CHOI, Los Angeles, CA (US)

(21) Appl. No.: 17/302,408

(22) Filed: May 3, 2021

(51) Int. Cl. H04W 40/02; H04W 76/14

(52) U.S. Cl. CPC H04W 40/02; H04W 76/14

(57) ABSTRACT

A mobile-to-mobile peering (M2MP) network is formed by connecting mobile stations (MS's) through peer-to-peer communication and multi-hop routing. Each MS is connectable to a radio access network (RAN) that connects to the Internet, and can function as a border gateway protocol (BGP) router, realizing IP packet communication between each MS and the Internet through the M2MP network and the RAN. Each MS uses a public IP address to directly access the Internet. A combination of using the public IP address and functioning as the BGP router enables each MS to run real-time interactive Internet applications through the M2MP network and the RAN. A MS may be implemented with a public IP server for providing Internet application services to any MS in the M2MP network, maintaining provision of these services to the MS's even if all the MS's cannot connect to the Internet.

### LIST OF ABBREVIATIONS

AS Autonomous systems

BGP Border Gateway Protocol

DHCP Dynamic Host Configuration Protocol

IETF Internet Engineering Task Force

IP Internet Protocol

ISP Internet service provider

M2MP Mobile-to-mobile peering

MS Mobile station

RF Radio frequency

RFC Request for Comment

WIFI Wireless Fidelity

### FIELD OF THE INVENTION

The present invention relates generally to a wireless network of plural MS's for connecting to the Internet and accessing Internet application services. In particular, the present invention relates to configuring an individual MS in the wireless network to function as a BGP router for facilitating IP packet communication between the individual MS and the Internet, and to configuring the individual MS to function as a public IP server for maintaining provision of the Internet application services to the MS's even if the wireless network is unable to connect to the Internet. The wireless network is named as a M2MP network.

### BACKGROUND

Currently, mobile phones are interconnected to the global Internet mostly via WIFI networks and cellular networks where IP traffics are delivered over RANs. Different from a computing server or a workstation, an individual mobile phone is assigned with a private IP address, not a public IP address, by a DHCP server from an access point of a WIFI network or from a core network of a cellular network. Using the private IP address has a disadvantage that the mobile phone can access the Internet only through a dedicated ISP that operates the DHCP server. The ISP translates the private IP address of the mobile phone to a public IP address of the ISP in forwarding and receiving IP packets on behalf of the mobile phone. If the WIFI network or cellular network to which the mobile phone is connected becomes unavailable, the mobile phone cannot communicate IP packets with the Internet even after the mobile phone re-connects to another RAN. It is because the private IP address is not recognized by the Internet. Thus, the advantage of disaster recovery and resilience provided by using the Internet is not readily obtained.

For illustration, FIG. 1 depicts an example scenario of mobile phones 151-155 making IP packet communication with the Internet 900, in particular with public IP servers 911-913 in the Internet 900. The IP packet communication is made through a mobile-system RAN 110 set up by a mobile communication system. The mobile phones 151-154, which are located inside a coverage area 111 of the mobile-system RAN 110, are wirelessly connected to a base station 115 thereof. The base station 115 is linked to a BGP router 921 such that IP packets delivered between the mobile phones 151-155 and the public IP servers 911-913 are routed by the BGP router 921. In order to make IP packet communication possible between the mobile phones 151-155 and the Internet 900, private IP addresses are assigned by the mobile communication system to the mobile phones 151-155 from the mobile-system RAN 110. If, for instance, the mobile phone 155 wishes to send IP packets to the server 911, the source IP address of the IP packets is translated from the private IP address of the mobile phone 155 to a public IP address owned by the mobile communication system before the IP packets are forwarded to the BGP router 921.

Suppose that the mobile-system RAN 110 fails such that mobile phones 151-155 lose connection to the Internet 900.

The mobile phone 155, which is also located inside a coverage area 121 of a WIFI RAN 120 of a WIFI system, reconnects to the Internet 900 through wirelessly connecting to an access point 125 of the WIFI RAN 120. The access point 125 is connected to the Internet 900 via a BGP router 922. Since the original IP address of the mobile phone 155 is a private one assigned from the mobile-system RAN 110 and is not a public IP address, this private IP address is not usable in making IP communication with the Internet 900 via the WIFI RAN 120. A new private IP address of the mobile phone 155 needs to be assigned from the WIFI RAN 120. Alternatively, it is more desirable if a public IP address can be assigned to and used by the mobile station 155 from the beginning such that uninterrupted connection to the server 911 for receiving certain Internet application services can be achieved.

The mobile phone 151, which is outside the coverage area 121 of the WIFI RAN 120, is not re-connectable to the Internet 900. Suppose that the mobile phone 151 received Internet application services from the server 912 before loss of connection to the Internet 900. Despite the connection to the Internet 900 is lost, it would be advantageous if the mobile phone 151 can still receive the same Internet application services.

There is a first need in the art for a technique to allow public IP addresses to be used by mobile phones, or mobile devices in general, in connecting to the Internet. In addition, there is a second need in the art for a corresponding technique that enables mobile devices to receive Internet application services even though the mobile devices are disconnected from the Internet.

### SUMMARY OF THE INVENTION

In a first aspect of the present invention, a M2MP network is provided. The M2MP comprises plural MS's. An individual MS is configured to conduct peer-to-peer communication and to wirelessly communicate with a RAN that connects to the Internet. The MS's are wirelessly connected through peer-to-peer communication and multi-hop routing to form the M2MP network. In addition, the individual MS is configured to function as a BGP router to obtain network connectivity information of the MS's and to manage IP packet routing. It causes the M2MP network to support not only peer-to-peer communication but also IP packet communication to thereby realize IP packet communication between the individual MS and the Internet through the M2MP network and the RAN even if some but not all the MS's are disconnected from the RAN. Furthermore, the individual MS uses a public IP address to directly access the Internet, thereby bypassing a need to use an intermediate gateway for translating a private IP address into a public one in accessing the Internet. A combination of using the public IP address and functioning as the BGP router for the individual MS advantageously enables the M2MP network to more quickly re-establish an Internet connection with the MS's in case one or more of the MS's are not stably connected to the RAN. The combination also enables the individual MS to run real-time interactive Internet applications through the M2MP network and the RAN even if some but not all the MS's are disconnected from the RAN.

Preferably, the MS's include one or more server-embedded MS's. An individual server-embedded MS includes a public IP server for providing Internet application services to any MS in the M2MP network. It thereby maintains provision of the Internet application services to the MS's even if all the MS's are unable to connect to the Internet. The individual server-embedded MS may be configured to activate the public IP server to function upon detecting that all the MS's are unable to connect to the Internet.

In certain embodiments, the individual server-embedded MS is configured such that the public IP server is realized as a mirror of a principal public IP server located in the Internet, thereby enabling the individual MS to continue to enjoy the Internet application services even after the M2MP network fails to connect to the Internet. The Internet application services may be real-time interactive Internet applications. It enables a user of the individual MS to continue to enjoy the real-time interactive Internet applications even after the M2MP network fails to connect to the Internet. The individual MS may be further configured such that the BGP router adopts a routing policy that IP packets heading to the principal public IP server are redirected to the public IP server when all the MS's are unable to connect to the Internet. In addition, the individual server-embedded MS may be further configured to activate the public IP server to provide the Internet application services upon detecting that all the MS's are unable to connect to the Internet.

In certain embodiments, the individual MS is further configured to form an AS, causing all the MS's in the M2MP network to be independent AS's such that the individual MS has full control of a routing policy in routing IP packets originated from or received by the individual MS to address needs of the individual MS without a burden to consider needs of remaining MS's in the M2MP network.

In certain embodiments, the individual MS is wirelessly communicable with the RAN under a communication protocol selected from the one or more predetermined communication protocols. The one or more predetermined communication protocols may include a mobile communication standard adopted by the public land mobile communication system.

In a second aspect of the present invention, a mobile computing device, usable to form a MS in realizing various embodiments of the M2MP network as disclosed in the first aspect of the present invention, is provided. The mobile computing device comprises one or more processors and one or more transceivers. The one or more transceivers are controllable by the one or more processors to conduct peer-to-peer communication and to wirelessly communicate with a RAN that connects to the Internet. The one or more processors are configured to achieve the following results. First, plural MS's each realized as the mobile computing device are wirelessly connectable through peer-to-peer communication and multi-hop routing to form a M2MP network. Second, the mobile computing device functions as a BGP router to obtain network connectivity information of the MS's and to manage IP packet routing, causing the M2MP network to support not only peer-to-peer communication but also IP packet communication so as to realize IP packet communication between an individual MS and the Internet through the M2MP network and the RAN even if some but not all of the MS's are disconnected from the RAN, thereby enabling a first MS selected from the MS's and not directly connected to the Internet to access the Internet. Third, the mobile computing device uses a public IP address to directly access the Internet, thereby bypassing a need to use an intermediate gateway for translating a private IP address into a public one in accessing the Internet. A combination of using the public IP address and functioning as the BGP router for the mobile computing device provides an advantage of enabling the M2MP network to more quickly re-establish an Internet connection with the MS's in case one or more of the MS's are not stably connected to the RAN. The combination also provides another advantage of enabling the mobile computing device to run real-time interactive Internet applications through the M2MP network and the RAN even if some but not all the MS's are disconnected from the RAN.

Preferably, the one or more processors are further configured such that the mobile computing device is selectable to function as a public IP server for providing Internet application services to any MS in the M2MP network. It thereby maintains provision of the Internet application services to the MS's even if all the MS's are unable to connect to the Internet. The one or more processors may be further configured to activate the public IP server to provide the Internet application services upon detecting that all the MS's are unable to connect to the Internet.

In certain embodiments, the public IP server may be realized as a mirror of a principal public IP server located in the Internet, thereby enabling any MS in the M2MP network to continue to enjoy the Internet application services even after the M2MP network fails to connect to the Internet. The Internet application services may be real-time interactive Internet applications. It enables a user of the individual MS to continue to enjoy the real-time interactive Internet applications even after the M2MP network fails to connect to the Internet. The one or more processors may be further configured such that the BGP router adopts a routing policy that IP packets heading to the principal public IP server are redirected to the public IP server when all the MS's are unable to connect to the Internet. In addition, the one or more processors may be further configured to activate the public IP server to provide the Internet application services upon detecting that all the MS's are unable to connect to the Internet.

In certain embodiments, the one or more processors are further configured such that the mobile computing device forms an AS, causing all the MS's in the M2MP network to be independent AS's such that the individual MS has full control of a routing policy in routing IP packets originated from or received by the individual MS to address needs of the individual MS without a burden to consider needs of remaining MS's in the M2MP network.

In certain embodiments, the one or more processors are further configured as follows. Upon detecting a disconnection from the RAN by the mobile computing device before the mobile computing device joins the M2MP network or before the M2MP network is created, the mobile computing device broadcasts a request for peer-to-peer communication through the one or more transceivers so as to create or join the M2MP network for establishing IP packet communication between the mobile computing device and the Internet. Upon detecting the disconnection from the RAN after the mobile computing device joins the M2MP network as a first MS, the mobile computing device broadcasts updated network connectivity information of the first MS to remaining MS's in the M2MP network.

In certain embodiments, the one or more transceivers are implemented with one or more predetermined communication protocols such that the mobile computing device is wirelessly communicable with the RAN under a communication protocol selected from the one or more predetermined communication protocols. In certain embodiments, the one or more predetermined communication protocols may include a mobile communication standard adopted in a public land mobile communication system.

In a third aspect of the present invention, a method for accessing the Internet by plural MS's is provided. An individual MS is configured to support peer-to-peer communication and to support wireless communication with a RAN that connects to the Internet. The method is developed according to various embodiments of the M2MP network disclosed in the first aspect of the present invention. The method comprises: wirelessly connecting the MS's through peer-to-peer communication and multi-hop routing to form a M2MP network; wirelessly connecting at least one of the MS's to the RAN; configuring the individual MS to function as a BGP router to obtain network connectivity information of the M2MP network and to manage IP packet routing, causing the M2MP network to support not only peer-to-peer communication but also IP packet communication; communicating IP packets between the individual MS and the Internet through the M2MP network and the RAN, thereby achieving IP packet communication between each of the MS's and the Internet even if some but not all of the MS's are disconnected from the RAN; and using a public IP address for the individual MS to directly access the Internet to thereby bypass a need to use an intermediate gateway for translating a private IP address into a public one in accessing the Internet. A combination of using the public IP address and functioning as the BGP router for the individual MS enables the M2MP network to more quickly re-establish an Internet connection with the MS's in case one or more of the MS's are not stably connected to the RAN as well as enables the individual MS to run real-time interactive Internet applications through the M2MP network and the RAN even if some but not all the MS's are disconnected from the RAN.

In certain embodiments, the method further comprises establishing the individual MS to be an AS to cause all the MS's in the M2MP network to be independent AS's such that the individual MS has full control of a routing policy in routing IP packets originated from or received by the individual MS to address needs of the individual MS without a burden to consider needs of remaining MS's in the M2MP network. It causes the M2MP network to be a decentralized network to thereby enhance scalability of the M2MP network.

In a fourth aspect of the present invention, a method for providing Internet application services to plural MS's is provided. An individual MS is configured to support peer-to-peer communication and to support wireless communication with a RAN that connects to the Internet. The method comprises: configuring the MS's to access the Internet according to any of the embodiments in the third aspect of the present invention; and setting up a server-embedded MS's among the MS's, wherein the server-embedded MS includes a public IP server for providing the Internet application services to any MS in the M2MP network, thereby maintaining provision of the Internet application services to the MS's even if all the MS's are unable to connect to the Internet.

In certain embodiments, the method further comprises configuring the server-embedded MS such that the public IP server is a mirror of a principal public IP server located in the Internet, thereby enabling the individual MS to continue to enjoy the Internet application services even after the M2MP network fails to connect to the Internet.

In certain embodiments, the Internet application services are real-time interactive Internet applications, thereby enabling a user of the individual MS to continue to enjoy the real-time interactive Internet applications even after the M2MP network fails to connect to the Internet.

In certain embodiments, the method further comprises configuring the individual MS such that the BGP router adopts a routing policy that IP packets heading to the principal public IP server are redirected to the public IP server when all the MS's are unable to connect to the Internet.

Other aspects of the present invention are disclosed as illustrated by the embodiments hereinafter.

### BRIEF DESCRIPTION OF THE DRAWINGS

FIG. 1 depicts an example scenario of mobile phones making IP packet communication with the Internet via a mobile communication system based on using private IP addresses for illustrating a problem that IP packet communication cannot be re-established after the mobile phones are re-connected to the Internet through another network.

FIG. 2 depicts a M2MP network interworking with a RAN that connects to the Internet in accordance with an exemplary embodiment of the present invention.

FIG. 3 depicts a schematic diagram of an exemplary mobile computing device for realizing an individual MS in the M2MP network.

FIG. 4 depicts a flowchart showing exemplary steps for accessing the Internet by means of the M2MP network.

FIG. 5 depicts a flowchart showing exemplary steps for providing Internet application services to plural MS's by means of the M2MP network and a server-embedded MS.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

As used herein, “a mobile computing device” is a portable electronic device having computing power and wireless-communication capability. A mobile computing device may be configured to be used by a human user. Examples of such mobile computing device include a smartphone, a handheld tablet computer, a notebook computer, etc. It is also possible that a mobile computing device is not primarily designed to interface with a human user. An example of such mobile computing device is a briefcase portable server.

As used herein, “a BGP” is an application-layer protocol accepted at any time by IETF or its successor for exchanging routing and reachability information among routers or AS's in the Internet. The aforesaid BGP is a standardized BGP defined in a relevant RFC document, such as RFC 4271, RFC 1883, RFC 2283 and RFC 4271.

As used herein, “a BGP router” is a router used for routing IP packets, and is installed with a BGP for exchanging routing and reachability information with other BGP routers.

As used herein, “an AS” is a collection of one or more connected computing devices under a control of a single administrative entity that presents a common, clearly defined routing policy to the Internet. A unique AS number is allocated to the AS for uniquely identifying the AS in the Internet and for use in BGP routing.

As used herein, “a cloud” or “a computing cloud” is interpreted in the sense of cloud computing or, synonymously, distributed computing over a network unless otherwise specified.

As used herein, “a server” is interpreted in the sense of computing. That is, a server is a computing server. A server is usually equipped with one or more processors for executing program instructions, and one or more storages for storing data. A server may be a standalone computing server (i.e. a physical server), a distributed server in the cloud, or a virtual server for handling clients' instructions. The one or more storages may be, for example, hard disks or solid-state disk drives.

As used herein, “an IP server” is a computing server installed with the IP suite such that the IP server is capable of supporting IP packet communication with other entities in the Internet.

A first aspect of the present invention is to provide a M2MP network formed with plural MS's, where IP packet communication is realized between an individual MS and the Internet through the M2MP network and a RAN that connects to the Internet even if some but not all the MS's are disconnected from the RAN. Advantageously, the individual MS is assigned with a pubic IP address as the individual MS also functions as a BGP router.

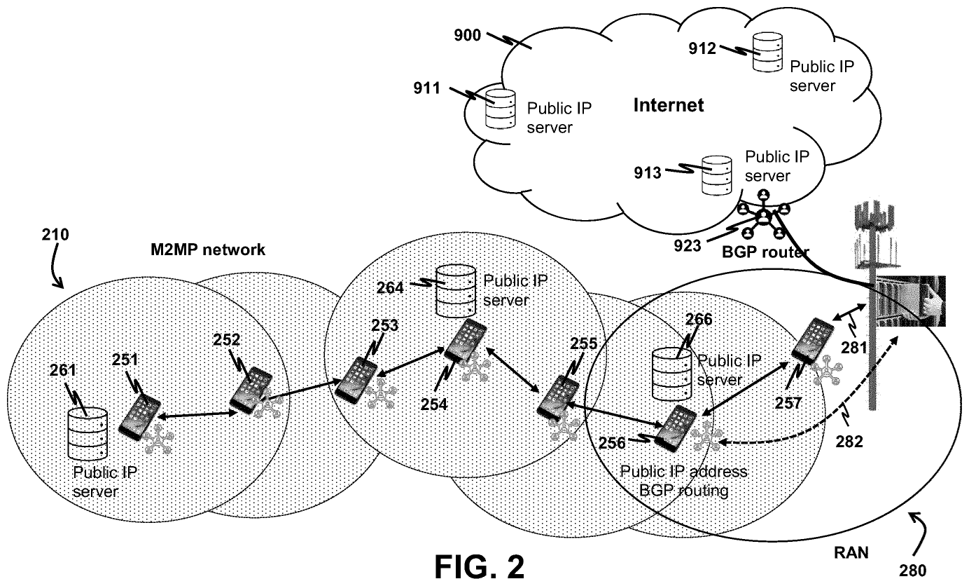

The disclosed M2MP network is illustrated with the aid of FIG. 2, which depicts an exemplary M2MP network 210 interworking with a RAN 280 that connects to the Internet 900. The M2MP network 210 comprises plural MS's 251-257. Each of the MS's 251-257 is usually a mobile computing device in practice. Although only seven MS's are shown in FIG. 2, the present invention is not limited to this number of MS's; the disclosed M2MP network may be formed with any number of MS's as deemed appropriate to those skilled in the art.

Each of the MS's 251-257 is installed with appropriate electronic circuits, digital logic circuits and RF communication circuits such that an individual MS is configured to conduct peer-to-peer communication and to wirelessly communicate with the RAN 280. Peer-to-peer communication is wireless communication between any two of the MS's 251-257 when the two MS's are within a communication range. As an example shown in FIG. 2, peer-to-peer communication is realized between the MS 251 and the MS 252, between the MS 252 and the MS 253, between the MS 253 and the MS 254, etc. It is also demonstrated as an example in FIG. 2 that the MS 257 wirelessly communicates with the RAN 280 via a first wireless link 281, and is also wirelessly connected to the MS 256 through peer-to-peer communication.

Although FIG. 2 depicts that one link (viz., the first wireless link 281) is used in connecting the M2MP network 210 to the RAN 280, in practice it is possible that multiple MS's individually establish independent links with the RAN 280. Thus, the M2MP network 210 is connected to the Internet 900 via multiple paths over the RAN 280. For example, a second wireless link 282 connecting the MS 256 and the RAN 280 may be optionally added to the M2MP network 210 such that there are two paths (the first and second wireless links 281, 282) linking the M2MP network 210 and the Internet 900.

Furthermore, the MS's 251-257 are wirelessly connected through peer-to-peer communication and multi-hop routing to form the M2MP network 210. It follows that the M2MP network 210 is a multi-hop network. Although FIG. 2 shows that the MS's 251-257 are linearly arranged in hop-to-hop connection, this arrangement is merely used as an example for illustration. In practical scenarios the MS's 251-257 are scattered over a geographical area. A topology more complex than a linear arrangement is usually resulted in connecting the MS's 251-257 in forming the M2MP network 210. For instance, one MS may be connected to more than two MS's, and a web-like topology may be formed such that more than one path exists for transmitting IP packets from one MS to another MS.

Particularly, each of the MS's 251-257 is configured to function as a BGP router to obtain network connectivity information of the MS's 251-257 and to manage routing of IP packets each either originated from or received by a respective MS, thereby enabling each of the MS's 251-257 to support IP packet switching. It causes the M2MP network 210 to support not only peer-to-peer communication but also IP packet communication. As a result, IP packet communication between the individual MS and the Internet 900 is realized through the M2MP network 210 and the RAN 280 even if some but not all the MS's 251-257 are disconnected from the RAN 280. Thereby, it enables a certain first MS selected from the MS's 251-257 and not directly connected to the Internet 900 to access the Internet 900. As an example shown in FIG. 2, the first MS may be any of the MS's 251-256.

Since the individual MS is configured to function as the BGP router, a public IP address is required to be assigned to the BGP router such that the BGP router is visible to the Internet 900 in receiving and broadcasting BGP messages. Since the BGP router is set up by the individual MS, it follows that the individual MS itself is assigned with a public IP address and uses this public IP address to directly access the Internet 900 through the M2MP network 210 and the RAN 280. Using the public IP address enables the individual MS to bypass a need to use an intermediate gateway (such as an ISP) to translate a private IP address into a public IP address in accessing the Internet 900. Using the public IP address is especially beneficial when the individual MS communicates IP packets with the public IP servers 911-913 in the Internet 900. Furthermore, as mentioned above, assigning the public IP address to the individual MS from the beginning enables uninterrupted connection to the public IP servers 911-913 for receiving Internet application services even if a connection between the individual MS and the RAN 280 suddenly fails.

Those skilled in the art will appreciate that acquisition of public IP addresses for assignment to the MS's 251-257 may be accomplished by following rules set forth by a relevant Internet administration body, e.g., a regional Internet registry. Both IPv4 and IPv6 addresses may be used as the public IP addresses.

A combination of using the public IP address and functioning as the BGP router provides the following major advantage. Conventionally, if a certain MS joins an ad hoc peer-to-peer communication network without a direct connection to the Internet 900, this MS cannot run real-time interactive Internet applications even if the ad hoc network has some MS's connected to the Internet 900. As each of the MS's 251-257 in the M2MP network 210 has a respective public IP address and functions as an independent BGP router, the M2MP network 210 that is formed is a part of the global Internet provided that at least one of the MS's 251-257 is also connected to the RAN 280, so that all the MS's 251-257 are effectively directly-connected to the Internet 900. Thus, the individual MS is enabled to run real-time interactive Internet applications through the M2MP network 210 and the RAN 280 even if some but not all the MS's 251-257 are disconnected from the RAN 280.

Furthermore, the combination of using the public IP address and functioning as the BGP router for the individual MS provides an additional advantage of enabling the M2MP network 210 to more quickly re-establish an Internet connection with the MS's 251-257 in case one or more of the MS's 251-257 are not stably connected to the RAN 280, as illustrated as follows. As mentioned above, it is possible that the M2MP network 210 connects to the Internet 900 via multiple paths over the RAN 280. Consider that the first and second wireless links 281, 282 are actively used by the M2MP network 210 for Internet access. Suppose that the first wireless link 281 is unstable. Different from a stationary computer with wireline connection to the Internet, instability of the first wireless link 281 may happen in practice due to, e.g., shadowing of the MS 257 from the RAN 280, running out of battery power of the MS 257, leaving the RAN 280 to enter into another RAN when the MS 257 travels in a high-speed vehicle, etc. When the link 281 is suddenly dropped, each of the MS's 251-257 in the M2MP network 210 is required to update its routing table for re-establishing the Internet connection with all the MS's 251-257. Respective routing tables of the MS's 251-257 are quickly updated as the individual MS is installed with a respective BGP router using a corresponding public IP address for communicating with other BGP routers. In particular, the MS 257 is able to quickly initiate BGP routing update upon detecting loss of connection to the RAN 280. On the other hand, BGP routing update is not possible without using public IP addresses for the MS's 251-257. If the MS's 251-257 use public IP addresses for Internet access but are not implemented as BGP routers, reconnection of the MS's 251-257 is wholly relied on actions taken by an external BGP router, e.g., a BGP router 923 located in the Internet 900. Due to remoteness from the M2MP network 210, the external BGP router may not be quick to initiate BGP routing update in comparison to the BGP router of the MS 257.

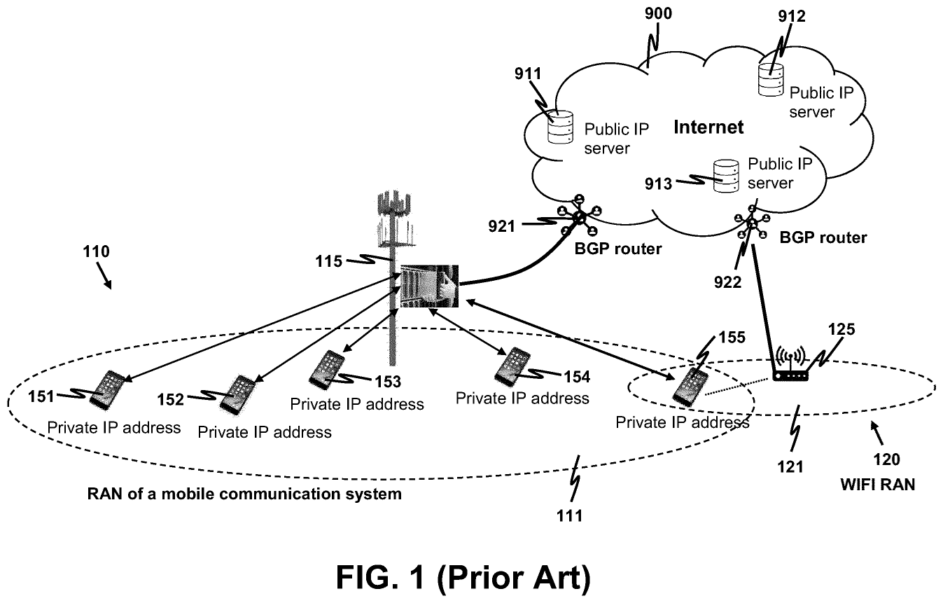

In the foregoing discussion, all the MS's 251-257 are connectable to the same RAN 280. In practice, it is possible that multiple co-existent RANs each connecting to the Internet 900 are connectable to different sets of the MS's 251-257 (for instance, the mobile-system RAN 110 and the WIFI RAN 120 of FIG. 1). In the presence of multiple co-existent RANs, the M2MP network 210 is connected to the Internet 900 through multiple paths. Similar to the case of the MS's 251-257 being connectable to the same RAN 280, the advantage of the combination of using the public IP address and functioning as the BGP router for the individual MS carries over to the case of multiple co-existent RANs.

Preferably and advantageously, the MS's 251-257 that form the M2MP network 210 include one or more server-embedded MS's. A server-embedded MS is a MS that includes, or is implemented with, a public IP server for providing Internet application services to any MS in the M2MP network 210, i.e. including the server-embedded MS itself. The public IP server may function all the time when the server-embedded MS is connected to the M2MP network 210. Alternatively, the public IP server may not be automatically activated upon the server-embedded MS joining the M2MP network 210; the public IP server is triggered to function by a certain event. In the latter case, the public IP server is usually put in a sleeping state (i.e. not activated) when the server-embedded MS is initially connected to the M2MP network 210. As examples shown in FIG. 2, the MS's 251, 254 and 256 are formed with public IP servers 261, 264 and 266, respectively. Accordingly, each of the public IP servers 261, 264 and 266 is a server-embedded MS. Each of the public IP servers 261, 264 and 266 may provide same or different Internet application services, depending on practical situations. Although each of the public IP servers 261, 264 and 266 is usually complex in implementation, realization of a moderately complex public IP server in a MS is practical nowadays and in the future with the advance of microelectronics. By having one or more of the MS's 251-257 as server-embedded MS's, it maintains provision of Internet application services to the MS's 251-257 even if all the MS's 251-257 are unable to connect to the Internet 900 due to, e.g., failed connection to the RAN 280.

The public IP server implemented in the server-embedded MS may use the same public IP address of the server-embedded MS, or may use a new public IP address different from the one used by the server-embedded MS. Using different public IP addresses for the public IP server and the server-embedded MS may be advantageous in certain practical situations in that private activities of the server-embedded MS and public activities performed by the public IP server may be more clearly separated.

In one option, the public IP server in a certain server-embedded MS is realized as a mirror (i.e. a mirror site) of a principal public IP server located in the Internet 900. Without loss of generality, consider that the public IP server 261 implemented in the MS 251 is a mirror of the principal public IP server 911 in the Internet 900, where the server 911 is used to provide certain Internet application services. In case the principal public IP server 911 is unavailable, the public IP server 261 replaces the principal public IP server 911 in providing the aforementioned services. One cause of unavailability of the principal public IP server 911 to the MS's 251-257 is that all the MS's 251-257 in the M2MP network 210 are unable to connect to the Internet 900, e.g., due to sudden break-down of the RAN 280. By installing a mirror site of the principal public IP server 911 in the M2MP network 210, each of the MS's 251-257 continues to enjoy the Internet application services even after the M2MP network 210 fails to connect to the Internet 900. The provision of continued services is particularly important to user experience if the Internet application services are real-time interactive applications. It enables a user of the individual MS to continue to enjoy the real-time interactive Internet applications even after the M2MP network 210 fails to connect to the Internet 900.

Preferably, each of the MS's 251-257 is further configured such that the BGP router realized by the individual MS adopts a routing policy that IP packets heading to the principal public IP server 911 are redirected to the public IP server 261 when all the MS's 251-257 are unable to connect to the Internet 900, or when the principal public IP server 911 is invisible to all the MS's 251-257.

It is also preferable that the MS 251 is further configured to activate the public IP server 261 to provide the Internet application services upon detecting that all the MS's 251-257 are unable to connect to the Internet 900. Accordingly, the public IP server 261 may not be activated to function if the MS 251, at the time of joining the M2MP network 210, finds that the M2MP network 210 is connected to the Internet 900.

In another option, the public IP server realized by a certain server-embedded MS is a standalone public IP server providing unique Internet application services not available elsewhere. For example, the public IP server 264 provides a certain application service aimed at efficiently managing resources (e.g., battery power) of all the MS's 251-257 present in the M2MP network 210.

Note that the BGP router realized by the individual MS is able to assign private AS numbers to different Internet entities so as to create independent AS's. Each AS has a clearly defined routing policy to the Internet 900. This feature of the AS is advantageously utilizable as follows. In certain embodiments, the individual MS is further configured to form an AS. It causes all the MS's 251-257 in the M2MP network 210 to be independent AS's. As a result, the individual MS (e.g., the MS 257) has full control of a routing policy in routing IP packets originated from or received by the individual MS to address needs of the individual MS without a burden to consider needs of remaining MS's (e.g., the MS's 251-256) in the M2MP network 210. By having full control of its routing policy for each of the MS's 251-257, the M2MP network 210 formed by the MS's 251-257 is a decentralized network. The decentralized network is simple to form and scaling the network is easy.

Generally, the individual MS (e.g., the MS 257) is further configured such that upon detecting a disconnection from the RAN 280 by the individual MS, the individual MS broadcasts updated network connectivity information of the individual MS to remaining MS's (e.g., the MS's 251-256) in the M2MP network 210.

The RAN 280 that interworks with the M2MP network 210 may be a private network, e.g., a private WIFI-based wireless local area network. Alternatively, the RAN 280 may belong to a public land mobile communication system, such as a 5G communication system. Generally, each of the MS's 251-257 is further configured to communicate with the

RAN 280 under a communication protocol selected from one or more predetermined communication protocols. The one or more predetermined communication protocols may include a WIFI specification, a mobile communication standard adopted in the public land mobile communication system, etc.

A second aspect of the present invention is to provide a mobile computing device usable to form a MS in realizing various embodiments of the M2MP network 210 as disclosed above in the first aspect of the present invention.

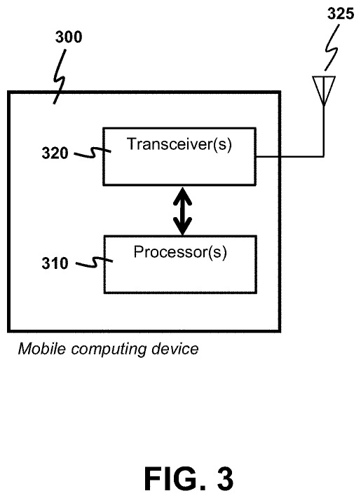

FIG. 3 depicts a schematic diagram of an exemplary mobile computing device 300. The mobile computing device 300 comprises one or more processors 310 and one or more transceivers 320. The one or more transceivers 320 are RF transceiver(s) configured to support peer-to-peer communication and to support wireless communication with a RAN that connects to the Internet 900 (e.g., the RAN 280). The one or more transceivers 320 are controllable by the one or more processors 310 to conduct peer-to-peer communication and to wirelessly communicate with the RAN. Generally, the mobile computing device 300 further comprises one or more antennas 325 (or a phased array antenna) coupled to the one or more transceivers 320 for RF signal transmission and reception. In particular, the one or more processors 310 are configured to realize various functions of an individual MS as disclosed above in the first aspect of the present invention.

Exemplarily, the one or more processors 310 are configured to achieve the following results. First, plural MS's each realized as the mobile computing device 300 are wirelessly connectable through peer-to-peer communication and multi-hop routing to form a M2MP network (e.g., the M2MP network 210). Second, the mobile computing device 300 functions as a BGP router to obtain network connectivity information of the MS's and to manage IP packet routing, causing the M2MP network to support not only peer-to-peer communication but also IP packet communication so as to realize IP packet communication between an individual MS and the Internet 900 through the M2MP network and the RAN even if some but not all of the MS's are disconnected from the RAN. It thereby enables a certain first MS selected from the MS's and not directly connected to the Internet 900 to access the Internet 900. Third, the mobile computing device 300 uses a public IP address to directly access the Internet 900, bypassing a need to use an intermediate gateway for translating a private IP address into a public one in accessing the Internet 900. Through a combination of using the public IP address and functioning as the BGP router for the mobile computing device 300, it enables the M2MP network to more quickly re-establish an Internet connection with the MS's in case one or more of the MS's are not stably connected to the RAN as well as enables the mobile computing device 300 to run real-time interactive Internet applications through the M2MP network and the RAN even if some but not all the MS's are disconnected from the RAN.

Preferably, the one or more processors 310 are further configured such that the mobile computing device 300 is selectable to function as a public IP server for providing Internet application services to any MS in the M2MP network. It thereby maintains provision of the Internet application services to the MS's even if all the MS's are unable to connect to the Internet 900. By being selectable to function as the public IP server, the public IP server is implemented in the mobile computing device 300, and the public IP server may be activated to function or be put in a sleeping state. By implementing the public IP server in the mobile computing device 300, the mobile computing device 300 forms a server-embedded MS. It is intended that the public IP server is realized with features as described above in the first aspect of the present invention.

In certain embodiments, the public IP server is realized as a mirror of a principal public IP server located in the Internet 900, thereby enabling any MS in the M2MP network to continue to enjoy the Internet application services even after the M2MP network fails to connect to the Internet 900. The Internet application services may be real-time interactive Internet applications. It enables a user of any MS in the M2MP network to continue to enjoy the real-time interactive Internet applications even after the M2MP network fails to connect to the Internet 900. The one or more processors 310 may be further configured such that the BGP router adopts a routing policy that IP packets heading to the principal public IP server are redirected to the public IP server when all the MS's in the M2MP network are unable to connect to the Internet 900, or when the principal public IP server is invisible to all the MS's.

In certain embodiments, the one or more processors 310 are further configured to activate the public IP server to provide the Internet application services upon detecting that all the MS's in the M2MP network are unable to connect to the Internet 900.

In certain embodiments, the one or more processors 310 are further configured such that the mobile computing device 300 forms an AS. It causes all the MS's in the M2MP network to be independent AS's. As an advantageous result mentioned above, the individual MS has full control of a routing policy in routing IP packets originated from or received by the individual MS to address needs of the individual MS without a burden to consider needs of remaining MS's in the M2MP network.

Usually, the one or more processors 310 are further configured as follows. Upon detecting a disconnection from the RAN by the mobile computing device 300 after the mobile computing device 300 joins the M2MP network as a certain MS, the mobile computing device 300 broadcasts updated network connectivity information of this MS to remaining MS's in the M2MP network. When a disconnection from the RAN is detected before the mobile computing device joins the M2MP network, the mobile computing device 300 broadcasts a request for peer-to-peer communication through the one or more transceivers 320 so as to create or join the M2MP network for establishing IP packet communication between the mobile computing device 300 and the Internet 900.

As mentioned above, the RAN that interworks with the M2MP network may be a private network, e.g., a private WIFI-based wireless local area network, or a public network, such as a public land mobile communication system. Generally, the one or more transceivers 320 are implemented with one or more predetermined communication protocols such that the mobile computing device 300 is wirelessly communicable with the RAN under a communication protocol selected from the one or more predetermined communication protocols. The one or more predetermined communication protocols may include a WIFI specification, a mobile communication standard adopted in the public land mobile communication system, etc.

In realizing the mobile computing device 300, each of the one or more processors 310 may be implemented by, e.g., a general-purpose computing processor, a special-purpose processor, a microcontroller, an application-specific integrated circuit, any programmable device/circuitry such as a field programmable gate array, or a combination thereof. Those skilled in the art will appreciate that other practical implementations of the one or more processors 310 are possible and can be designed according to knowledge in the art.

A third aspect of the present invention is to provide a method for accessing the Internet 900 by plural MS's. An individual MS is configured to support peer-to-peer communication and to support wireless communication with a RAN that connects to the Internet 900. The method is developed according to various embodiments of the M2MP network 210 as disclosed above in the first aspect of the present invention.

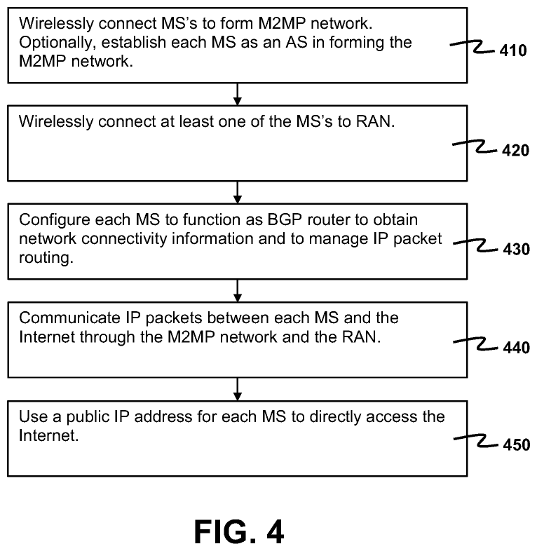

FIG. 4 depicts a flowchart showing exemplary steps of the disclosed method. The disclosed method comprises steps 410, 420, 430, 440 and 450.

In the step 410, the MS's are wirelessly connected through peer-to-peer communication and multi-hop routing to form a M2MP network. Optionally, the individual MS is established to be an AS to cause all the MS's in the M2MP network to be independent AS's. As a result, the individual MS has full control of a routing policy in routing IP packets originated from or received by the individual MS to address needs of the individual MS without a burden to consider needs of remaining MS's in the M2MP network. It causes the M2MP network to be a decentralized network to thereby enhance scalability of the M2MP network.

In the step 420, at least one of the MS's is wirelessly connected to the RAN. It is possible that all the MS's in the M2MP network are connected to the RAN.

In the step 430, the individual MS is configured to function as a BGP router to obtain network connectivity information of the M2MP network and to manage IP packet routing. It causes the M2MP network to support not only peer-to-peer communication but also IP packet communication.

In the step 440, IP packets are communicated between the individual MS and the Internet 900 through the M2MP network and the RAN. It thereby achieves IP packet communication between each of the MS's and the Internet 900 even if some but not all of the MS's are disconnected from the RAN.

In the step 450, the individual MS uses a public IP address to directly access the Internet 900 to thereby bypass a need to use an intermediate gateway for translating a private IP address into a public one in accessing the Internet 900. A combination of using the public IP address and functioning as the BGP router for the individual MS provides advantageous effects that it enables the M2MP network to more quickly re-establish an Internet connection with the MS's in case one or more of the MS's are not stably connected to the RAN as well as enables the individual MS to run real-time interactive Internet applications through the M2MP network and the RAN even if some but not all the MS's are disconnected from the RAN.

Although the steps 410, 420, 430, 440 and 450 are arranged in a sequential order in FIG. 4 for illustrating an exemplary flow of steps of the disclosed method, it is possible to re-order these steps or execute some of the steps in parallel as deemed appropriate by those skilled in the art without changing desirable effects achievable by the disclosed method.

A fourth aspect of the present invention is to provide a method for providing Internet application services to plural MS's. An individual MS is configured to support peer-to-peer communication and to support wireless communication with a RAN that connects to the Internet 900. The method for providing the Internet application services is developed according to various embodiments of the M2MP network 210 and of the method for accessing the Internet 900 as disclosed above in the first and third aspects of the present invention.

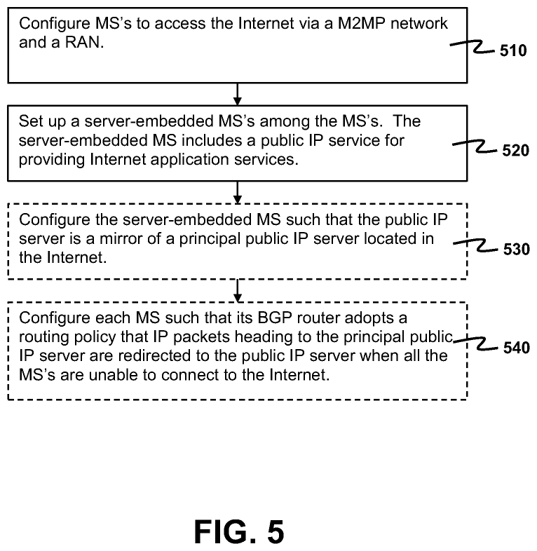

FIG. 5 depicts a flowchart showing exemplary steps of the disclosed method for providing the Internet application services to the MS's.

In a step 510, the MS's are configured to access the Internet 900 according to any of the embodiments of the method for accessing the Internet 900 as disclosed in the third aspect of the present invention. Thereby, a M2MP network is set up to connect the MS's through peer-to-peer communication, and each of the MS's accesses the Internet 900 via the M2MP network and the RAN.

In a step 520, one MS among the MS's is selected and is set up as a server-embedded MS. The server-embedded MS includes a public IP server for providing the Internet application services to any MS in the M2MP network, thereby maintaining provision of the Internet application services to the MS's even if all the MS's are unable to connect to the Internet 900.

In certain embodiments, the server-embedded MS is configured such that the public IP server is a mirror of a principal public IP server located in the Internet (step 530), thereby enabling the individual MS to continue to enjoy the Internet application services even after the M2MP network fails to connect to the Internet 900. In certain embodiments, the Internet application services are real-time interactive Internet applications, thereby enabling a user of the individual MS to continue to enjoy the real-time interactive Internet applications even after the M2MP network fails to connect to the Internet 900.

In certain embodiments, the individual MS is configured such that the BGP router adopts a routing policy that IP packets heading to the principal public IP server are redirected to the public IP server when all the MS's are unable to connect to the Internet 900 (step 540).

Although the steps 510, 520, 530 and 540 are arranged in a sequential order in FIG. 5 for illustrating an exemplary flow of steps of the disclosed method, it is possible to re-order these steps or execute some of the steps in parallel as deemed appropriate by those skilled in the art without changing desirable effects achievable by the disclosed method.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

What is claimed is:

1. A mobile-to-mobile peering (M2MP) network comprising plural mobile stations (MS's), wherein:
an individual MS is configured to conduct peer-to-peer communication and to wirelessly communicate with a radio access network (RAN) that connects to the Internet;
the MS's are wirelessly connected through peer-to-peer communication and multi-hop routing to form the M2MP network;
the individual MS is configured to function as a border gateway protocol (BGP) router to obtain network connectivity information of the MS's and to manage Internet Protocol (IP) packet routing, causing the M2MP network to support not only peer-to-peer communication but also IP packet communication to thereby realize IP packet communication between the individual MS and the Internet through the M2MP network and the RAN even if some but not all the MS's are disconnected from the RAN; and
the individual MS uses a public IP address to directly access the Internet, bypassing a need to use an intermediate gateway for translating a private IP address into a public one in accessing the Internet, whereby a combination of using the public IP address and functioning as the BGP router for the individual MS enables the M2MP network to more quickly re-establish an Internet connection with the MS's in case one or more of the MS's are not stably connected to the RAN as well as enables the individual MS to run real-time interactive Internet applications through the M2MP network and the RAN even if some but not all the MS's are disconnected from the RAN.

2. The M2MP network of claim 1, wherein the MS's include one or more server-embedded MS's, an individual server-embedded MS including a public IP server for providing Internet application services to any MS in the M2MP network, thereby maintaining provision of the Internet application services to the MS's even if all the MS's are unable to connect to the Internet.

3. The M2MP network of claim 2, wherein the individual server-embedded MS is configured such that the public IP server is realized as a mirror of a principal public IP server located in the Internet, thereby enabling the individual MS to continue to enjoy the Internet application services even after the M2MP network fails to connect to the Internet.

4. The M2MP network of claim 3, wherein the Internet application services are the real-time interactive Internet applications, thereby enabling a user of the individual MS to continue to enjoy the real-time interactive Internet applications even after the M2MP network fails to connect to the Internet.

5. The M2MP network of claim 3, wherein the individual MS is further configured such that the BGP router adopts a routing policy that IP packets heading to the principal public IP server are redirected to the public IP server when all the MS's are unable to connect to the Internet.

6. The M2MP network of claim 5, wherein the individual server-embedded MS is further configured to activate the public IP server to provide the Internet application services upon detecting that all the MS's are unable to connect to the Internet.

7. The M2MP network of claim 3, wherein the individual server-embedded MS is configured to activate the public IP server to function upon detecting that all the MS's are unable to connect to the Internet.

8. The M2MP network of claim 1, wherein the individual MS is further configured to form an autonomous system (AS), causing all the MS's in the M2MP network to be independent AS's such that the individual MS has full control of a routing policy in routing IP packets originated from or received by the individual MS to address needs of the individual MS without a burden to consider needs of remaining MS's in the M2MP network.

9. The M2MP network of claim 1, wherein the individual MS is wirelessly communicable with the RAN under a communication protocol selected from the one or more predetermined communication protocols, the one or more predetermined communication protocols including a mobile communication standard adopted by the public land mobile communication system.

10. A method for accessing the Internet by plural mobile stations (MS's), an individual MS being configured to support peer-to-peer communication and to support wireless communication with a radio access network (RAN) that connects to the Internet, the method comprising:
wirelessly connecting the MS's through peer-to-peer communication and multi-hop routing to form a mobile-to-mobile peering (M2MP) network;
wirelessly connecting at least one of the MS's to the RAN;
configuring the individual MS to function as a border gateway protocol (BGP) router to obtain network connectivity information of the M2MP network and to manage IP packet routing, causing the M2MP network to support not only peer-to-peer communication but also IP packet communication;
communicating IP packets between the individual MS and the Internet through the M2MP network and the RAN, thereby achieving IP packet communication between each of the MS's and the Internet even if some but not all of the MS's are disconnected from the RAN; and
using a public IP address for the individual MS to directly access the Internet to thereby bypass a need to use an intermediate gateway for translating a private IP address into a public one in accessing the Internet, whereby a combination of using the public IP address and functioning as the BGP router for the individual MS enables the M2MP network to more quickly re-establish an Internet connection with the MS's in case one or more of the MS's are not stably connected to the RAN as well as enables the individual MS to run real-time interactive Internet applications through the M2MP network and the RAN even if some but not all the MS's are disconnected from the RAN.

11. The method of claim 10 further comprising:
establishing the individual MS to be an autonomous system (AS) to cause all the MS's in the M2MP network to be independent AS's such that the individual MS has full control of a routing policy in routing IP packets originated from or received by the individual MS to address needs of the individual MS without a burden to consider needs of remaining MS's in the M2MP network, causing the M2MP network to be a decentralized network to thereby enhance scalability of the M2MP network.

12. A method for providing Internet application services to plural mobile stations (MS's), an individual MS being configured to support peer-to-peer communication and to support wireless communication with a radio access network (RAN) that connects to the Internet, the method comprising:
configuring the MS's to access the Internet according to the method of claim 10; and
setting up a server-embedded MS's among the MS's, wherein the server-embedded MS includes a public IP server for providing the Internet application services to any MS in the M2MP network, thereby maintaining provision of the Internet application services to the MS's even if all the MS's are unable to connect to the Internet.

13. The method of claim 12 further comprising:
configuring the server-embedded MS such that the public IP server is a mirror of a principal public IP server located in the Internet, thereby enabling the individual MS to continue to enjoy the Internet application services even after the M2MP network fails to connect to the Internet.

14. The method of claim 13, wherein the Internet application services are the real-time interactive Internet applications, thereby enabling a user of the individual MS to continue to enjoy the real-time interactive Internet applications even after the M2MP network fails to connect to the Internet.

15. A mobile computing device comprising one or more processors and one or more transceivers, wherein:
the one or more transceivers are controllable by the one or more processors to conduct peer-to-peer communication and to wirelessly communicate with a radio access network (RAN) that connects to the Internet; and
the one or more processors are configured such that:
plural mobile stations (MS's) each realized as the mobile computing device are wirelessly connectable through peer-to-peer communication and multi-hop routing to form a mobile-to-mobile peering (M2MP) network;
the mobile computing device functions as a border gateway protocol (BGP) router to obtain network connectivity information of the MS's and to manage Internet Protocol (IP) packet routing, causing the M2MP network to support not only peer-to-peer communication but also IP packet communication so as to realize IP packet communication between an individual MS and the Internet through the M2MP network and the RAN even if some but not all of the MS's are disconnected from the RAN, thereby enabling a first MS selected from the MS's and not directly connected to the Internet to access the Internet; and
the mobile computing device uses a public IP address to directly access the Internet, bypassing a need to use an intermediate gateway for translating a private IP address into a public one in accessing the Internet, whereby a combination of using the public IP address and functioning as the BGP router for the mobile computing device enables the M2MP network to more quickly re-establish an Internet connection with the MS's in case one or more of the MS's are not stably connected to the RAN as well as enables the mobile computing device to run real-time interactive Internet applications through the M2MP network and the RAN even if some but not all the MS's are disconnected from the RAN.

16. The mobile computing device of claim 15, wherein the one or more processors are further configured such that the mobile computing device is selectable to function as a public IP server for providing Internet application services to any MS in the M2MP network, thereby maintaining provision of the Internet application services to the MS's even if all the MS's are unable to connect to the Internet.

17. The mobile computing device of claim 15, wherein the public IP server is realized as a mirror of a principal public IP server located in the Internet, thereby enabling any MS in the M2MP network to continue to enjoy the Internet application services even after the M2MP network fails to connect to the Internet.

18. The mobile computing device of claim 17, wherein the Internet application services are the real-time interactive Internet applications, thereby enabling a user of any MS in the M2MP network to continue to enjoy the real-time interactive Internet applications even after the M2MP network fails to connect to the Internet.

19. The mobile computing device of claim 17, wherein the one or more processors are further configured such that the BGP router adopts a routing policy that IP packets heading to the principal public IP server are redirected to the public IP server when all the MS's are unable to connect to the Internet.

20. The mobile computing device of claim 19, wherein the one or more processors are further configured to activate the public IP server to provide the Internet application services upon detecting that all the MS's are unable to connect to the Internet.

21. The mobile computing device of claim 16, wherein the one or more processors are further configured to activate the public IP server to provide the Internet application services upon detecting that all the MS's are unable to connect to the Internet.

22. The mobile computing device of claim 15, wherein the one or more processors are further configured such that the mobile computing device forms an autonomous system (AS), causing all the MS's in the M2MP network to be independent AS's such that the individual MS has full control of a routing policy in routing IP packets originated from or received by the individual MS to address needs of the individual MS without a burden to consider needs of remaining MS's in the M2MP network.

23. The mobile computing device of claim 15, wherein the one or more processors are further configured to:
upon detecting a disconnection from the RAN by the mobile computing device before the mobile computing device joins the M2MP network or before the M2MP network is created, broadcast a request for peer-to-peer communication through the one or more transceivers so as to create or join the M2MP network for establishing IP packet communication between the mobile computing device and the Internet; and
upon detecting the disconnection from the RAN after the mobile computing device joins the M2MP network as a first MS, broadcast updated network connectivity information of the first MS to remaining MS's in the M2MP network.

24. The mobile computing device of claim 15, wherein the one or more transceivers are implemented with one or more predetermined communication protocols such that the mobile computing device is wirelessly communicable with the RAN under a communication protocol selected from the one or more predetermined communication protocols, the one or more predetermined communication protocols including a mobile communication standard adopted in a public land mobile communication system.
